(19) United States
(12) Patent Application Publication
(10) Pub. No.: US 2013/0151257 A1
(43) Pub. Date: Jun. 13, 2013

(54) APPARATUS AND METHOD FOR PROVIDING EMOTIONAL CONTEXT TO TEXTUAL ELECTRONIC COMMUNICATION

(71) Applicants: Andrew MacMannis, Hermosa Beach, CA (US); McCarthy Whit, Hermosa Beach, CA (US)

(72) Inventors: Andrew MacMannis, Hermosa Beach, CA (US); McCarthy Whit, Hermosa Beach, CA (US)

(21) Appl. No.: 13/243,523

(22) Filed: Dec. 9, 2011

(51) Int. Cl. G10L 11/00

(52) U.S. Cl. 704/270; 704/E11.001

(57) ABSTRACT

An apparatus and method for including emotional context in textual electronic communication transmissions. The emotional context is conveyed symbolically through standardized alternations in the manner in which the text is displayed without the inclusion of additional graphics, thereby increasing the communicative value of textual electronic communication. An important advantage of this method of embedding emotional context is that the recipient is made aware of the mental and emotional state of to the originator while the textual electronic message is being received and interpreted and therefore is able to interpret the message in light of the emotional context.

### FIELD OF THE PRESENT DISCLOSURE

This disclosure relates generally to electronic communication, and more particularly to enhancing textual electronic communication to provide users with an efficient and convenient means of augmenting written electronic communication by embedding additional information regarding the mental and emotional state of the originator of the communication thereby increasing its communicative value and decreasing the probability that the message may be misconstrued or misinterpreted.

### BACKGROUND OF THE RELATED ART

Traditional face-to-face human communication is comprised of a highly complex combination of verbal and non-verbal channels. The non-verbal portions are primarily visual including communication through gestures, body position such as posture and proximity, facial expressions, and eye position and movement. Haptic behaviors such as touching one's arm or placing an arm around another's shoulders may also influence the meaning of the overall message. The verbal portion of face-to-face human communication is comprised of more than words as well. Speech elements known as paralanguage enhance or alter the communicator's meaning. These elements include voice quality, rate, pitch, volume, speaking style as well as prosodic qualities such as rhythm and intonation. Further compounding the complexity, the same verbal and non-verbal communication can take on different meanings depending on the milieu of the particular social situation.

When traditional face-to-face human communication is reduced to text for transmission via an electronic communication systems many of the verbal and non-verbal channels of communication are not represented. If the transmitted message consists merely of words, it is stripped of the wealth of traditionally accompanying context. This can result in a number of interpretation errors ranging from misconstruing the emotional state of the originator to a complete misinterpretation of the meaning of the message.

As electronic communication has grown to play a more prominent role in how society communicates with each other, the deficiencies of textual communication have become a more substantial concern. Consequently, there have been a myriad of attempts to increase the communicative power of such media. The methods range from adopting a vernacular designed to textually describe the state of mind of the originator such as “Ion” to indicate the originator is “laughing out loud” or “jk” to indicate the originator intends the message to be interpreted as a joke to ASCII art such as “: (” or “: P” where the communication's originator attempts to graphically represent the facial expression that will best assist the recipient to interpret the message appropriately. More advanced systems have taken the ASCII art concept a step further and provided the originator with a variety of graphical facial expressions called emoticons to add emotional context for the recipient's benefit.

Emoticons and ASCII art have their limitations as well. Some people dislike the whimsical connotation that is often associated with the use of emoticons and ASCII art and feel that their use is inappropriate for more serious situations such as business. Others may forgo the use emoticons and ASCII art because they feel that the graphics are so clever or cute that they distract from the emotion that the message is trying to convey such as anger or sadness. Emoticons and ACII art are also limited in that they clutter the message if inserted after every sentence and therefore they are typically only used sparingly at the end of a message to approximate the overall emotional state of the sender. This leaves the sender without a practical ability to express multiple emotions or states of mind in relation to various portions of one message. Further, while there are a plethora of emoticons and ASCII art designs available, it is sometime difficult to reflect combinations of emotions that the sender desires to express.

Another limitation of the state of the art is that emotional indicators often convey emotional context to the receiving party after the message is received rather than while the message is being interpreted. This may seem like a subtle difference but its impact can be significant. Introducing emotional context during the interpretation of textual communication impacts interpretation in much the same way tone of voice and facial expressions impact interpretation in face-to-face verbal communications. If emotional context is introduced after interpretation, interpretation may be initially flawed and then corrected. Initial unintended impressions may persist even after correction.

The present disclosure distinguishes over the related art providing heretofore unknown advantages as described in the following summary.

### BRIEF SUMMARY OF THE INVENTION

The present disclosure describes an improved method and apparatus for efficiently and conveniently communicating via textual electronic media.

The electronic communication system of the presently disclosed apparatus and method shares many basic similarities with electronic communication systems that are known in the art; however, it also contains an innovative approach that yields many unrealized advantages. The apparatus comprises an emotion indicator module that contains a plurality of emotional indicators that represent a humans' emotions, communication tones, and feelings that an individual may desire to convey to the recipient of the textual electronic message. Each human emotion is assigned a unique emotional indicator which when activated alters the text in a visually perceptible manner so that when the recipient is reading the textual electronic communication he or she is immediately alerted of the emotional context in which the originator intended the message to be interpreted. The textual alterations may include color, emphasis, font, underlining, or style. An advantage of using color, emphasis, font, underlining, and style to visually distinguish emotional context in the textual electronic messages is that these alterations have relatively few, if any, pre-existing social connotations. This means that use of these emotional indicators are less likely to be avoided due to dislike of the associated social mores.

The important benefit of this feature is that the emotional context is embedded in the text rather than being communicated through the use of additional graphics. This alerts the recipient to the intended emotional tone of the message prior to or simultaneous with the recipient's interpretation of the message. Being aware of the emotional context to before or during interpretation allows the recipient to use the emotional context to assist interpretation giving the recipient a greater ability to interpret the message as the originator intended. This is in contrast to the use of emoticons or ASCII art which are usually used at the end of a message and serve the purpose of correcting or altering interpretation after the recipient has received and interpreted the textual communication unassisted by any emotional context.

Initially, as the system is introduced, many individuals may not be familiar with the emotion associated with each emotional indicator. This issue can be addressed by providing the recipient a drop-down or pop-up menu populated with the various available human emotions and the associated emotional indicators. Alternatively, in some embodiments, an explanation of the human emotions associated with the emotional indicators may appear when prompted by the recipient. Prompting may involve activating an explanation mode that provides a description emotion associated with the emotional indicator in parenthesis or denoted from the text of the message in some other manner. Explanations may also be provided if the message is sent to an electronic communication device that cannot support the graphical requirements of the particular emotional indicator. As the system gains popularity and users gain familiarity with the standard emotional indicators the need for explanation will likely diminish.

The presently disclosed apparatus also features a convenient and efficient manner of selecting among the available emotional indicators so that the originator is required to invest only a minimal time and efforts to enhance the communicative value of his or her message. This is critical to the success of the presently disclosed apparatus and method because a significant limitation of emoticons and ASCII art is the time and effort required to insert or create them.

Convenience and efficiency can be provided by a variety of methods. In one embodiment the apparatus features and drop down or pop-up menu activated by either an icon or similar conveniently located emotion indicator selector. The message originator may then manipulate the emotion indicator selector to identify a particular emotion to convey. Once selected, any text entered into the electronic communications device will be displayed in the unique visual appearance of the selected emotion indicator until the emotion indicator is unselected or another emotion indicator is selected.

In other embodiments text may be selected and then assigned an emotion indicator after the text is entered using the emotion indicator selector feature. In this embodiment users may enter the entire text message into the electronic communication device and then select and apply emotional indicators throughout as desired. An advantage of this method of operation is the ease of editing. Some embodiments may feature both this methods of operation and the method previously disclosed in paragraph thirteen to efficiently accommodate the needs of the user.

Some embodiments may allow the same textual electronic communication to exhibit two or more emotion indicators so long as each emotion indicator may be expressed simultaneously. This may occur by choosing emotion indicators that are not inherently conflicting such as italicized text and colored text or by displaying text in more than one color. This also may be achieved by alternating colors within the same line of text. For example sentence may begin with red text and end in green text.

Other embodiments of the presently disclosed apparatus may feature physical emotion selectors such as a dial or series of buttons so that the originator of a message may very quickly select the desired emotional indicator while entering the text of the message without significant delay or hassle. Advanced embodiments may allow users to select and apply emotion indicators by verbal commands. The emotional indicator selector may take a variety of forms depending on the particular electronic communication device so long as the selector is convenient and efficient.

This disclosure teaches certain benefits in construction and use which give rise to the objectives described below.

A primary objective inherent in the above described method and apparatus is to provide an apparatus and method of providing emotional context to textual electronic communication.

Another objective is to provide an apparatus and method of providing emotional context in a convenient and efficient manner by inserting emotional indicators into textual electronic communication.

A further objective is to provide an apparatus and method of providing emotional context to textual electronic communication that is relatively free of existing social connotations and associations.

A still further objective is to provide an apparatus and method of providing complex emotional context including a plurality of emotional indicators to a single textual electronic communication.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

The accompanying drawings illustrate various exemplary implementations and are part of the specification. The illustrated implementations are proffered for purposes of example not for purposes of limitation. Illustrated elements will be designated by numbers. Once designated, an element will be identified by the identical number throughout. Illustrated in the accompanying drawings is at least one of the best mode embodiments of the present disclosure. In such drawings:

FIG. 1 is a graphical representation of an exemplary embodiment of the presently described apparatus;

FIG. 2 is a chart of exemplar emotions and associated emotional indicators available in an exemplary embodiment of the presently described apparatus;

FIG. 3 is a flowchart of a method for providing emotional context in textual electronic communication in an exemplary embodiment of the presently described apparatus;

FIG. 4 is a flowchart of a method for providing emotional context in textual electronic communication in an exemplary embodiment of the presently described apparatus;

### DETAILED DESCRIPTION OF THE EXEMPLARY EMBODIMENT

The above described drawing figures illustrate an exemplary embodiment of an apparatus and method of use in at least one of its preferred, best mode embodiments, which is further defined in detail in the following description. Those having ordinary skill in the art may be able to make alterations and modifications to what is described herein without departing from its spirit and scope of the disclosure. Therefore, it must be understood that what is illustrated is set forth only for the purposes of example and that it should not be taken as a limitation in the scope of the present apparatus and method of use.

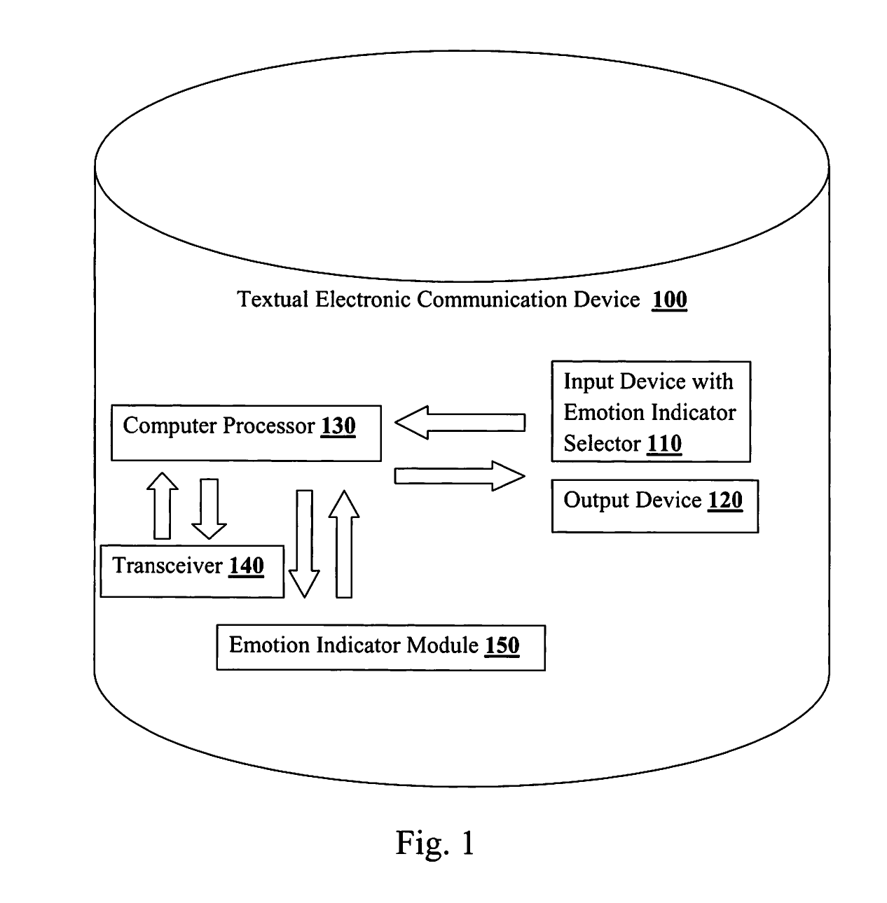

Described now in detail is an apparatus and method of efficiently conveniently embedding emotional context into textual electronic communication. FIG. 1 is an exemplary embodiment of the enhanced electronic communications apparatus 100. This figure depicts a device with a computer processor 130, transceiver 140, input device 110, an output device 120, and most importantly, an emotion indicator module 150.

The input device 110 can vary depending on the form of electronic communications apparatus 100. If the apparatus 100 is a personal computer or laptop then the input device is the keyboard, touchpad, mouse and/or similar peripheral. If the apparatus 100 is a smart phone the input device 110 may be either a micro keyboard as featured on many of the blackberry brand devices or if a interactive touch screen as is featured on many apple brand products. Regardless of the style of the communication apparatus 100 each input device 110 features an emotion indicator selector. The emotion indicator selector may be a physical key or button on the device or it can be an icon or option on a menu that when selected activates a pop-up or drop-down menu facilitating the selection of the appropriate emotion indicator.

The output device 120 is a graphical interface capable of displaying textual communications. It may be a screen as commonly used with personal computers or laptops or it may be a more compact display as is commonly featured on smart phones and other personal communication devices. Because many of the emotional indicators are differentiated by color, it is preferred that the output device 120 is capable of displaying text in color. However, in some embodiments of the present disclosure, the device is capable of including an alternative emotional indicator if it detects that the output device is not capable of displaying color. An example of an alternative emotional indicator may be a textual representation of the color that would be displayed if the output device 120 was able (e.g. “(green)”).

The most important feature of the presently disclosed textual communication device is the emotion indicator module 150. The emotion indicator module 150 contains the software instructions for the output device 120 to display the desired alterations to the selected text. When a user selects an emotional indicator to activate or selects a portion of text and applies an emotional indicator, the emotional indicator module provides the software instruction that dictates the particular visually perceptible alteration to the text.

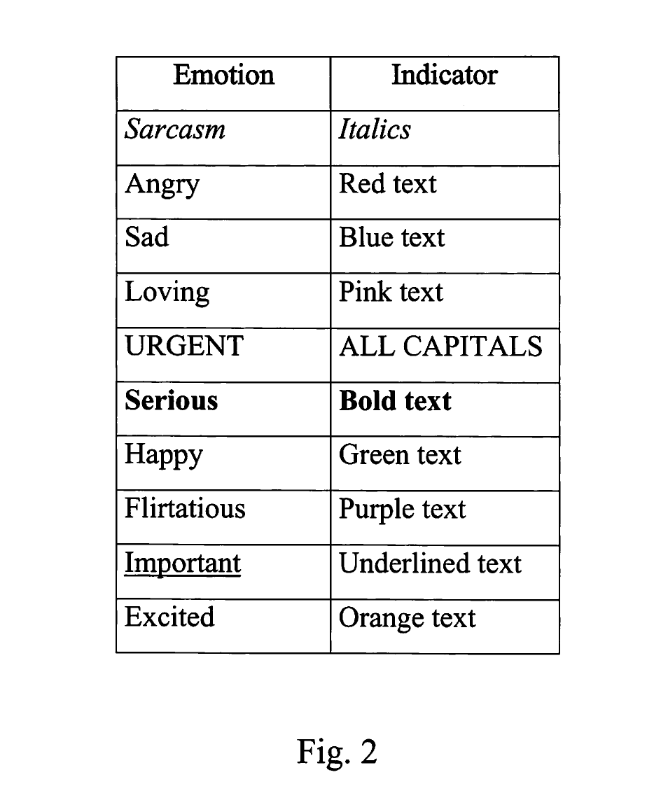

FIG. 2 is a chart that depicts various human emotions and the assigned emotional indicator. These are for example only. The present disclosure is not dependant on any particular association of emotional indicator to human emotion; however, the system does depend on some level of consistency. For a recipient to receive the emotional communication simultaneously with the textual message the recipient should be aware of the emotions represented by the emotional indicators. Many associations are readily apparent and easy to anticipate such as “red” for anger or “bold” for serious. Less apparent associations may be learned by recipients through use. Many embodiments include an optional tutorial whereby a recipient can activate a pop-up or drop-down index menu similar to the FIG. 2 for reference if they are unfamiliar with a particular emotion indicator.

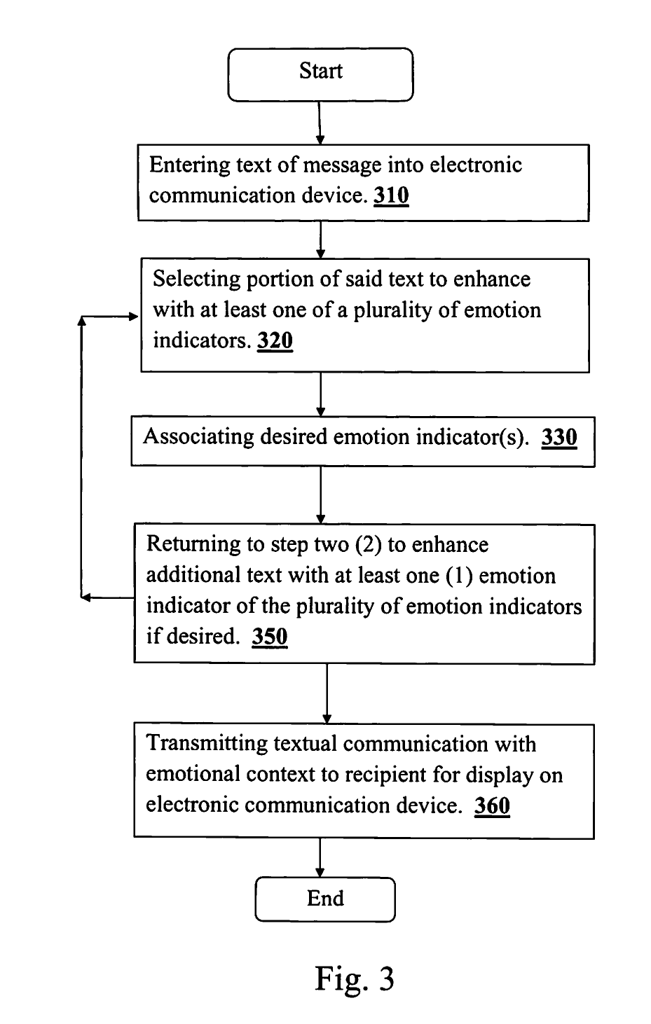

FIG. 3 is a flowchart describing one method of applying emotional indicators. The process is provided as an example of how the present disclosure may be implemented and is not intended to be the only manner possible. The process starts with entering text 310 into the input device 110. This step may be executed as it would normally be executed if the device had no emotion indicator module 150 or capabilities. After the text has been entered, the portion of the text that the message originator wishes to enhance with emotional context is then selected 320. The selection may be executed by highlighting or dragging the cursor across the desired text in a manner dictated by the particular communication device. Once text has been selected, the originator may then activate the emotion indicator selector to view a menu of available human emotions and select the desired emotion to communicate. In some embodiments more than one emotion may be applied to the same selected text. The message originator may return to the text selection step to select additional text and apply additional emotion indicators through the message 350. When the originator is finished applying emotional indicators the message may be sent 360.

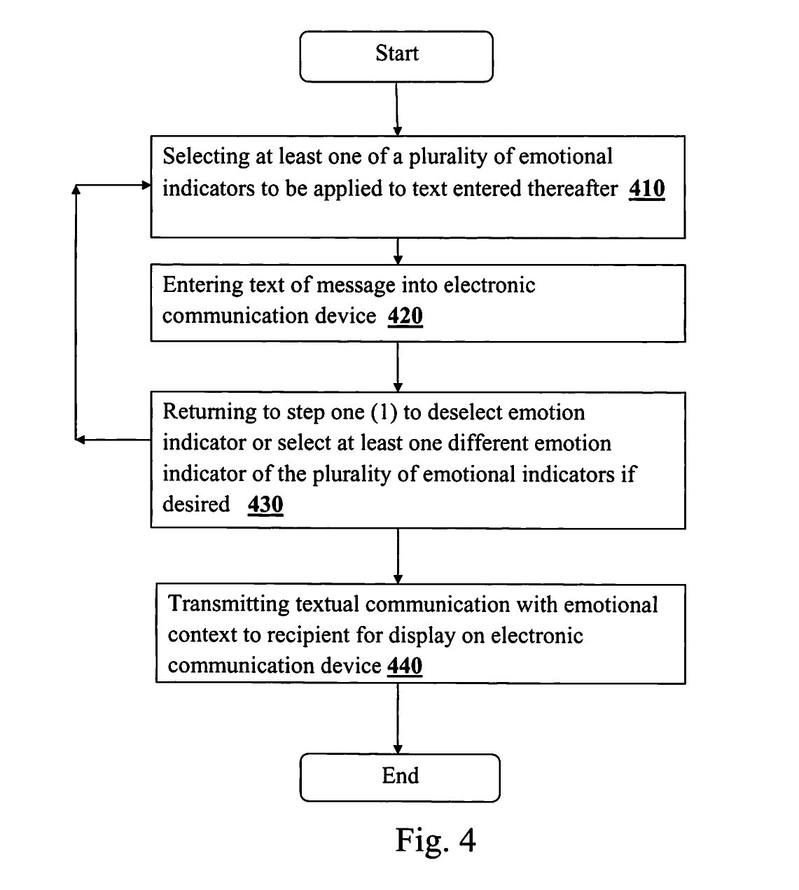

FIG. 4 describes a more streamline method of applying emotion indicators. This alternative method begins with accessing the emotional indicator module and activating one or more emotional indicators 410. Once activated any text entered in the input device 110 will automatically be associated with the selected emotion indicators 420. If the message originator wishes to deactivate the association or select a different emotion indicator he or she may return to the emotion indicator module and change and select different emotion indicator(s) 430. When finished the message may be transmitted 440. Some embodiments may feature both described methods of operation and allow the operator to activate the preferred method.

The enablements described in detail above are considered novel over the prior art of record and are considered critical to the operation of at least one aspect of the apparatus and its method of use, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that the named inventors believe that the claimed subject matter is what is intended to be patented.

What is claimed is:

1. An apparatus for transmitting textual electronic communication, the apparatus comprising:
at least one input device for receiving both textual and emotional communication instructions for electronic transmission;
at least one output device for graphically displaying textual and emotional communication;
at least one transceiver for both receiving textual and emotional electronic communication instructions from other electronic communication devices and transmitting textual and emotional communication instructions to other electronic communication devices;
an emotion indictor module for providing the software instructions regarding the application of emotion indicators to the graphically displayed text;
a computer processor in communication with said input device, said output device, said transceiver, and said emotion indicator module to control the textual electronic communication apparatus.

2. An apparatus as in claim 1, wherein said emotion indicator module includes software instructions to assign visually perceptible alterations associated with the selected emotion indicator to selected text.

3. An apparatus as in claim 2, wherein said visually perceptible alterations do not include the display of graphical characters other than the alphanumeric characters of the selected text.

4. An apparatus as in claim 3, wherein each said emotional indicator is associated with and represents a unique human emotion.

5. An apparatus as in claim 4, wherein said emotional indicator module is capable of assigning the multiple emotional indicators throughout the text of a single textual electronic communication.

6. An apparatus in claim 5, wherein said emotional indicator module is capable of assigning multiple emotional indicators to the same text within a single textual electronic communication.

7. An apparatus as in claim 6 wherein said emotion indicator module comprises software instructions to provide a menu of emotion indicators and associated human emotions upon prompting.

8. An apparatus as in claim 7 wherein said input device includes an emotion indicator selector to facilitate the selection of and assignment of an emotion indictor to particular text.

9. An apparatus as in claim 8, wherein said transceiver is a cellular telephone transmitter and receiver.

10. An apparatus as in claim 9, wherein said transceiver is an Internet modem capable of transmitting and receiving electronic communication via Internet protocol.

11. A method for providing emotional context to textual electronic communication, method comprising the steps of
1) entering the text into the electronic communication device;
2) selecting the portion of said text to enhance with at least one of a plurality of emotion indicators;
3) associating desired emotion indicator(s);
4) returning to the step two (2) to enhance additional text with at least one emotion indicator of the plurality of emotion indicators if desired;
5) transmitting textual communication with emotional context to recipient for display on electronic communication device.

12. A method as in claim 11, wherein said emotion indicators consist of visually perceptible alterations to the displayed selected text.

13. A method as in claim 12, wherein said emotion indicator does not include the display of graphical characters other than the alphanumeric characters of the selected text.

14. A method as in claim 12, wherein said emotion indicator consists of an alteration of the color of the selected text.

15. A method as in claim 12, wherein said emotion indicator consist of underlining the selected text.

16. A method for providing emotional context to textual electronic communication, method comprising the steps of:
1) selecting at least one of a plurality of emotion indicators to be applied to text entered thereafter;
2) entering the text into the electronic communication device;
3) returning to step one (1) to deselect emotion indicator or select at least one different emotion indicator of the plurality of emotion indicators if desired;
4) transmitting textual communication with emotional context to recipient for display on electronic communication device

17. A method as in claim 16, wherein said emotion indicators consist of visually perceptible alterations to the displayed selected text.

18. A method as in claim 17, wherein said emotion indicator does not include the display of graphical characters other than the alphanumeric characters of the selected text.

19. A method as in claim 17, wherein said emotion indicator consists of an alteration of the color of the selected text.

20. A method as in claim 17, wherein said emotion indicator consist of underlining the selected text.
